(19) United States
(12) Patent Application Publication
(10) Pub. No.: US 2012/0139909 A1
(43) Pub. Date: Jun. 7, 2012

(54) 3D DISPLAY APPARATUS AND METHOD OF DISPLAYING 3D IMAGES

(75) Inventors: Kyu-hwan CHOI, Yongin-si (KR); Hong-seok Lee, Seongnam-si (KR); Yoon-sun Choi, Yongin-si (KR); Jung-mok Bae, Seoul (KR); Hoon Song, Yongin-si (KR)

(73) Assignee: SAMSUNG ELECTRONICS CO., LTD., Suwon-si (KR)

(21) Appl. No.: 13/298,142

(22) Filed: Nov. 16, 2011

(30) Foreign Application Priority Data
Dec. 7, 2010 (KR) 10-2010-0124230

(51) Int. Cl. G06T 15/00

(52) U.S. Cl. 345/419

(57) ABSTRACT

A three-dimensional (3D) display apparatus and methods of displaying 3D images are provided. A 3D display apparatus includes a light source, a display unit, an active optical device for changing a travel path of light, and a plurality of projection optical systems.

### CROSS-REFERENCE TO RELATED APPLICATIONS

This application claims the benefit of Korean Patent Application No. 10-2010-0124230, filed on Dec. 7, 2010, in the Korean Intellectual Property Office, the entire disclosure of which is incorporated herein by reference for all purposes.

### BACKGROUND

1. Field

The following description relates to three-dimensional (3 D) display apparatuses and methods of displaying 3D images with multiple view points.

2. Description of the Related Art

Three-dimensional (3D) image display apparatuses are used in various fields, including games, advertisements, medical images, educations, military fields, and the like. Also, along with the popularization of high definition televisions (HDTVs), 3D TVs that allow a user to watch a 3D image have been commercialized. Accordingly, various 3D image display technologies have been proposed. A currently commercialized 3D image display apparatus uses the binocular parallax of human eyes. Thus, a user may experience a 3D effect by the 3D image display apparatus providing a left-eye image and a right-eye image, each of which has different viewing points corresponding to the user's left-eye and right-eye, respectively. The 3D image display apparatus may be a glasses-type 3D image display apparatus which requires the user to wear special glasses, or an autostereoscopic 3D image display apparatus which does not require special glasses.

However, a conventional 3D image display apparatus providing only two viewing points of a left-eye image and a right-eye image is limited in its ability to provide a natural 3D effect, because the conventional 3D image display apparatus does not provide a change in viewing point when a viewer moves. Thus, a multi-view 3D image display apparatus that provides multiple views is proposed, to provide a more natural motion parallax.

The multi-view 3D image display apparatus provides 3D images having different viewing points to a plurality of viewing zones. However, in the multi-view 3D image display apparatus, crosstalk may occur between different viewing zones, such that a non-3D zone or a reverse 3D zone may occur between the plurality of viewing zones. Also, because the number of viewing points is increased to provide the more natural motion parallax, image definition at a given unit viewing point may deteriorate. In an example of a 3D image display apparatus that uses a projection optical system, the number of projection optical systems is increased to increase the number of viewing points, but this increase in the number of projection optical systems results in an increase of a size of a whole system. Furthermore, because a conventional multi-view 3D image display apparatus only provides binocular parallax, it is generally not possible to view a 3D image in a monocular way.

A super multi-view 3D image display apparatus has been proposed to provide more natural motion parallax and to also allow a viewer to watch a 3D image in a monocular manner. The super multi-view 3D image display apparatus provides images having a plurality of viewing points to an eye of the viewer. For this, the super multi-view 3D image display apparatus generates images having a plurality of viewing points in an area of the viewer's eye smaller than a size of a pupil. Because the images having a plurality of parallaxes are substantially simultaneously projected to a retina of the viewer, the viewer may experience a 3D effect with only one eye, so that a more natural 3D effect may be created.

### SUMMARY

Provided are a projection type multi-view three-dimensional (3D) display apparatus. Also provided are methods of displaying 3D images by generating a plurality of virtual images.

Additional aspects will be set forth in part in the description which follows and, in part, will be apparent from the description, or may be learned by practice of the presented examples.

According to one general aspect, there is provided a three-dimensional (3D) display apparatus including a light source which emits light; a display panel which generates according to the light emitted from the light source; an active optical device which changes a travel path of light including the images generated by the display panel, and which generates a plurality of virtual images in a time-division manner; and a plurality of projection optical systems which respectively project the plurality of virtual images.

The active optical device may include an optical plate which adjusts a refraction direction of light by adjusting a rotation angle of the optical plate.

The rotation angle of the optical plate may be mechanically or electrically adjusted.

The active optical device may include an electro-wetting prism having a refractive surface whose slope is changed by an application of a voltage to the active optical device.

The display panel may include a Digital Micromirror Device (DMD).

A first mirror may be disposed in an optical path between the active optical device and a first projection optical system from among the plurality of projection optical systems, and a second mirror may be disposed in an optical path between the active optical device and a second projection optical system from among the plurality of projection optical systems, wherein the first mirror and the second mirror may respectively reflect the light including the plurality of virtual images from the active optical device.

The display panel may generate images having time-sequentially different viewing points.

The active optical device may be substantially synchronized with the display panel, and the active optical device may refract light including images having different viewing points by different angles.

The 3D display apparatus may be included in a super multi-view system.

The 3D display apparatus may be included in a high-density direction display system.

According to another general aspect, there is provided a method of displaying three-dimensional (3D) images including the operations of emitting light from a light source; generating images according to the light emitted from the light source, wherein the images are generated by a display panel; changing a travel path of light including the images generated by the display panel, wherein an active optical device changes the travel path of the light comprising the images; generating a plurality of virtual images in a time-division manner, wherein the active optical device generates the plurality of virtual images; and projecting each of the plurality of virtual images respectively from each of a plurality of projection optical systems.

In yet another general aspect, there is provided A three-dimensional (3D) display apparatus including a first projection system; and a second projection system, wherein each of the first and second projection systems include a light source which emits light; a display panel which generates images according to the light emitted from the light source; an active optical device which changes a travel path of light comprising the images generated by the display panel; and a plurality of projection optical devices project virtual images according to an output of the active optical device.

the first and second projection systems may be substantially simultaneously operated to separately generate respective virtual images in a time-division manner.

The 3D display apparatus may further include one or more additional projection systems in addition to the first and second projection systems.

Other features and aspects may be apparent from the following detailed description, the drawings, and the claims.

### BRIEF DESCRIPTION OF THE DRAWINGS

FIG. 1 is a diagram illustrating an example of a three-dimensional (3D) display apparatus.

FIGS. 2A through 2C illustrate examples of an active optical device included in a 3D display apparatus.

FIGS. 3A through 3C illustrate other examples of an active optical device included in a 3D display apparatus.

FIG. 4 is a diagram illustrating an example of a 3D display apparatus.

FIG. 5 is a diagram illustrating an example of images having a plurality of viewing points being formed on a retina of a viewer according to an operation of a 3D display apparatus.

FIG. 6 is a diagram illustrating an example of a relation between a pixel angle pitch on a screen and a distance from the screen to eyes of a viewer, wherein the relation satisfies a super multi-view condition.

FIG. 7 is a diagram illustrating a an example of a 3D display apparatus.

FIG. 8 is a diagram illustrating an example of a 3D display apparatus that includes a plurality of projection systems.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

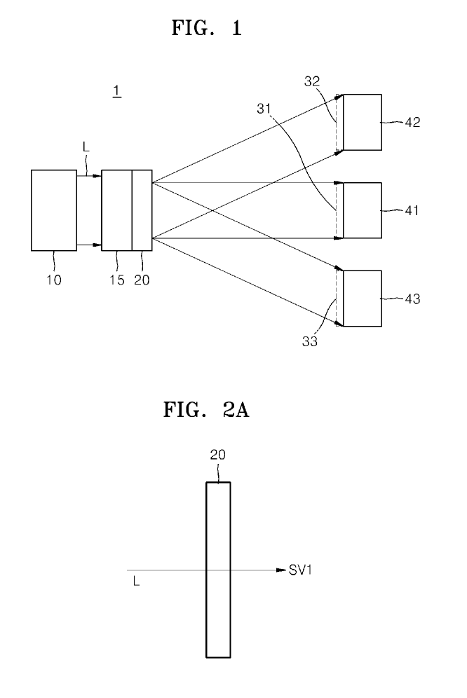

FIG. 1 illustrates an example of a three-dimensional (3D) display apparatus 1. Referring to FIG. 1, the 3D display apparatus 1 may include a light source 10 for emitting light, a display panel 15 that generates an image by using the light emitted from the light source 10, and an active optical device 20 that may change a path of the light generated by the display panel 15. For example the active optical device 20 may change the path of the light which forms the image.

The light source 10 may include an incandescent electric lamp, a fluorescent lamp, a Light Emitting Device (LED), or the like. The display panel 15 may include a Liquid Crystal Display (LCD), a Ferro Liquid Crystal Display (FLCD), a Liquid Crystal On Silicon (LCOS), a Digital Micromirror Device (DMD), or the like. The LCD or the FLCD may be implemented by forming a thin film transistor (TFT) and an electrode in a unit of a pixel, and an image may be displayed by applying an electric field to the LCD or the FLCD. The DMD may be implemented by arraying a plurality of micromirrors in a two-dimensional (2D) manner, and each of the micromirrors may independently operate. According to a rotation direction of each micromirror, a pixel may be controlled to turn-on and turn-off in order to generate an image.

The active optical device 20 may selectively change a travel path of light including an image generated by the display panel 15, and may accordingly generate a plurality of virtual images. For example, the active optical device 20 may provide the plurality of virtual images in a time-division manner by adjusting a refraction angle of the light. The display panel 15 may generate images having different viewing points in a time-sequential manner. The active optical device 20 may be synchronized with the display panel 15, may refract light including the images having the different viewing points to different angles, and may generate a plurality of virtual images. FIG. 1 illustrates an example in which the plurality of virtual images include a first virtual image 31, a second virtual image 32, and a third virtual image 33. The 3D display apparatus 1 may include a plurality of projection optical systems, for respectively projecting each of the plurality of virtual images. For example, first through third projection optical systems 41, 42, and 43 may be arranged to correspond to the first through third virtual images 31, 32, and 33. By generating the plurality of virtual images at an intermediate location of the travel path of light according to the active optical device 20, the 3D display apparatus 1 may be implemented as a projection type multi-view 3D display apparatus or a projection type super multi-view 3D display apparatus.

For example, the active optical device 20 may include a rotational optical plate. A rotation speed of the active optical device 20 may be selected based on, for example, a driving speed of a display panel and the number of virtual images.

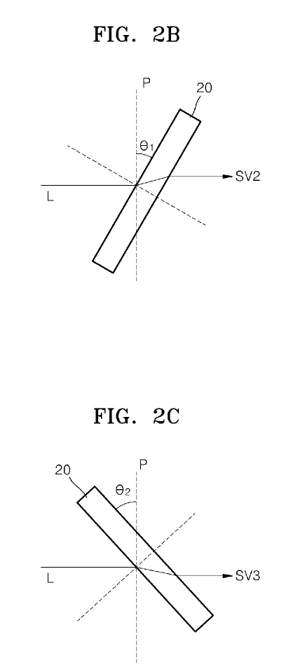

FIGS. 2A through 2C illustrate examples of an active optical device 20. The active optical device 20 may be formed of a material having a refractive index different from a refractive index of an adjacent layer, so that the active optical device 20 may adjust a travel path of light. For example, the active optical device 20 may be formed of a light-transmitting material having a different refractive index from that of air. The active optical device 20 may mechanically or electrically rotate to a desired angle. According to the rotation angle of the active optical device 20, the travel path of light may be changed. As illustrated in FIG. 2A, if the active optical device 20 does not rotate and is therefore substantially perpendicular to a travel path of light L, the light L may pass through the active optical device 20 in a substantially straight path to form a virtual image at a first point sv1. Referring to FIG. 2B, the active optical device 20 may be rotated to a first angle θ1 with respect to a reference axis p that is perpendicular to a travel path of light L. The active optical device 20 refracts the light L, which may thereby form a virtual image at a second point sv2, which is different from the first point sv1. Referring to FIG. 2C, the active optical device 20 may be rotated to a second angle θ2 with respect to a reference line p that is perpendicular to a travel path of light L. The active optical device 20 refacts the light L, which may thereby form a virtual image at a third point sv3, which different from the first and second points sv1 and sv2. In the examples illustrated in FIGS. 2A through 2C, virtual images may be formed at three points; however, the number of virtual images may be adjusted according to the rotation angle of the active optical device 20. In addition, a distance between the virtual images may be adjusted according to the rotation angle of the active optical device 20. Accordingly, images having a plurality of viewing points may be provided to a pupil of a viewer in a time-division manner.

The display panel 15 may generate images having different viewing points in a time sequential manner. The active optical device 20 may be driven in synchronization with outputs of the images generated by the display panel 15. For example, when an image having a first viewing point is output from the display panel 15, the active optical device 20 may be driven to be in a substantially vertical state as illustrated in FIG. 2A. When an image having a second viewing point is output from the display panel 15, the active optical device 20 may rotate to the first angle θ1 as illustrated in FIG. 2B. When an image having a third viewing point is output from the display panel 15, the active optical device 20 may rotate to the second angle θ2 as illustrated in FIG. 2C. A plurality of virtual images having additional viewing points may be generated according to a driving speed and the rotation angle of the active optical device 20. The plurality of virtual images may be magnified and projected via projection optical systems that respectively correspond to the virtual images.

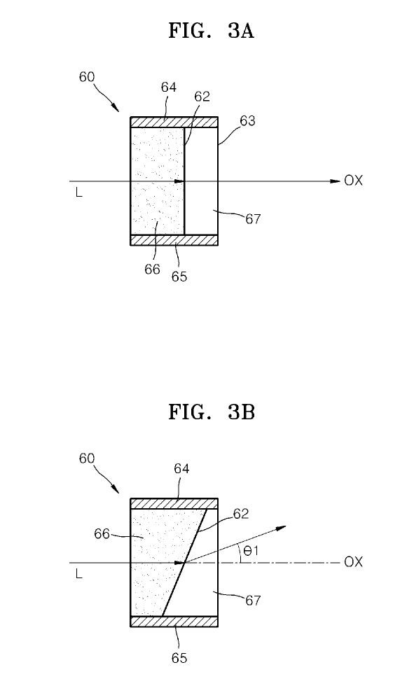

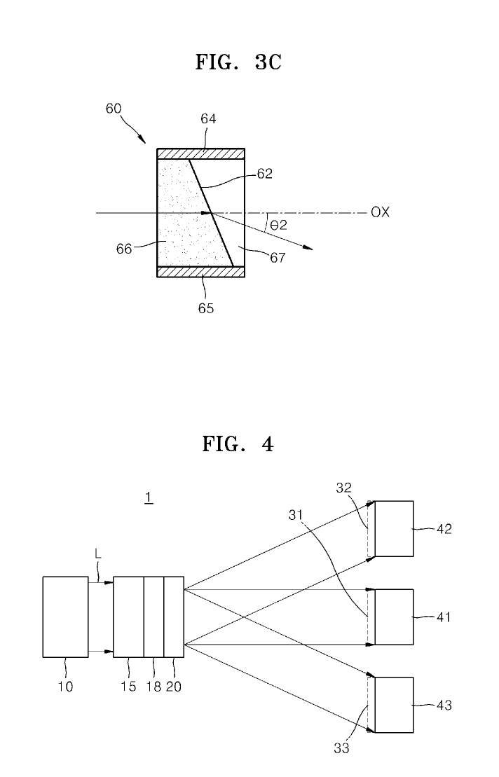

As another example of an active optical device 20, the active optical device 20 may be formed as an electro-wetting prism. FIGS. 3A through 3C illustrate examples of an electro-wetting prism 60. The electro-wetting prism 60 may adjust a travel path of light by adjusting a slope of a refractive surface 62 according to an electrical signal. Multiple views may be generated by controlling a travel direction of light by adjusting the slope of the refractive surface 62. The electro-wetting prism 60 may include a first electrode 64 and a second electrode 65 within a partition wall 63, and may include a polarizable liquid 66 (as an example, water) and a monopolar liquid 67 (as an example, oil) disposed between the first electrode 64 and the second electrode 65. The partition wall 63 may encompass the outer surface of the electro-wetting prism 60. An interface formed between the polarizable liquid 66 and the monopolar liquid 67 is the refractive surface 62. The slope of the refractive surface 62 may be changed by application of a voltage across the first and second electrodes 64 and 65. When the slope of the refractive surface 62 is changed, the travel path of light is changed accordingly. In this manner, by applying a voltage to the first and second electrodes 64 and 65 (e.g., an “ON” state) or not applying a voltage thereto (e.g., an “OFF” state), the travel path of light may be controlled. The travel path of light may also be controlled by adjusting a level of the voltage applied across the first and second electrodes 64 and 65. For example, the travel path of light is controlled according to an electro-wetting principle; however, control of the travel path of light is not limited thereto. For example, in an implementation where images are generated with polarized light, the travel path may be controlled by a liquid crystal. In this example, an array of liquid crystal particles may be changed according to a level of an electric field that is generated by a voltage applied to an electrode, thereby changing a refractive index of the liquid crystal. As a further example, the active optical device 20 may be formed as an optical prism.

FIGS. 3A through 3C illustrate examples of operations of the electro-wetting prism 60. Referring to FIG. 3A, if the refractive surface 62 of the electro-wetting prism 60 is not sloped, light L passes through the electro-wetting prism 60 without any substantial change in its travel path. As illustrated in FIG. 3B, the refractive surface 62 may be sloped by a first angle by electrically controlling the electro-wetting prism 60. The light L is refracted by the refractive surface 62 by an angle of θ1 with respect to an optical axis OX as the light L passes through the electro-wetting prism 60. As illustrated in FIG. 3C, the refractive surface 62 may be sloped by a second angle by electrically controlling the electro-wetting prism 60. The light L is refracted by the refractive surface 62 by an angle of (−)θ2 with respect to the optical axis OX as the light L passes through the electro-wetting prism 60.

The electro-wetting prism 60 may be driven in synchronization with an output of images generated by the display panel 15. For example, when an image having a first viewing point is output from the display panel 15, the electro-wetting prism 60 may be driven to be at the substantially vertical state illustrated in FIG. 3A. When an image having a second viewing point is output from the display panel 15, the electro-wetting prism 60 may be sloped by the first angle as illustrated in FIG. 3B. When an image having a third viewing point is output from the display panel 15, the electro-wetting prism 60 may be sloped by the second angle as illustrated in FIG. 3C. According to a driving speed of the electro-wetting prism 60 and the slope of the refractive surface 62, a plurality of virtual images may be generated. As illustrated in FIG. 1, the active optical device 20 is disposed adjacent to the display panel 15. However, the positions of the display panel 15 and the active optical device 20 may be switched.

FIG. 4 illustrates another example of a 3D display apparatus. In contrast to the 3D display apparatus 1 illustrated in FIG. 1, the 3D display apparatus of FIG. 4 further includes a 3D optical unit 18 disposed between the display panel 15 and the active optical device 20. The 3D optical unit may be included to divide viewing points. The other elements illustrated in FIG. 4 are the same as, or similar to, those illustrated in FIG. 1, and thus detailed descriptions thereof are omitted here.

The 3D optical unit 18 may be formed as a device that includes a lenticular lens array, a microlens array, or a parallax barrier for dividing viewing zones. The 3D optical unit 18 may be included so that an image output from the display panel 15 is formed at a plurality of viewing points. Various known techniques for dividing viewing points with the 3D optical unit 18 may be applied, and thus a detailed description thereof is omitted here. It is also noted that specially designed techniques may also be applied for dividing viewing points, as would be suggested by the descriptions provided herein.

As one example, the number of viewing points may be doubled in a 3D display apparatus that includes both the 3D optical unit 18 and the active optical device 20. For example, when the 3D optical unit 18 displays images having two viewing points and the active optical device 20 displays images having three viewing points, virtual images having a total of six viewing points may be generated. As another example, when the 3D optical unit 18 displays images having eight viewing points and the active optical device 20 displays images having five viewing points, virtual images having a total of forty viewing points may be generated. In this manner, the number of virtual images may be significantly increased by including the 3D optical unit 18 with the active optical device 20. Because the active optical device 20 generates virtual images by changing a travel path of light including images generated by the display panel 15, the number of viewing points may be increased without deterioration of the definition of the images by the 3D optical unit 18. Thus, by including the active optical device 20 in 3D display apparatus 1, multi-view or super multi-view 3D images may be realized without deterioration of definition. In the example illustrated FIG. 4, the 3D optical unit 18 is disposed between the display panel 15 and the active optical device 20. However, in another implementation, the active optical device 20 may be disposed between the display panel 15 and the 3D optical unit 18.

As described above, the 3D display apparatus according to one or more of the examples described above may generate a plurality of virtual images at an intermediate location of an optical path by using the active optical device 20, and thus may create an effect by which 3D images are displayed by using a plurality of projection systems. Thus, a size of a whole system may be decreased, compared to a 3D display apparatus that requests projection systems corresponding to the number of necessary viewing points.

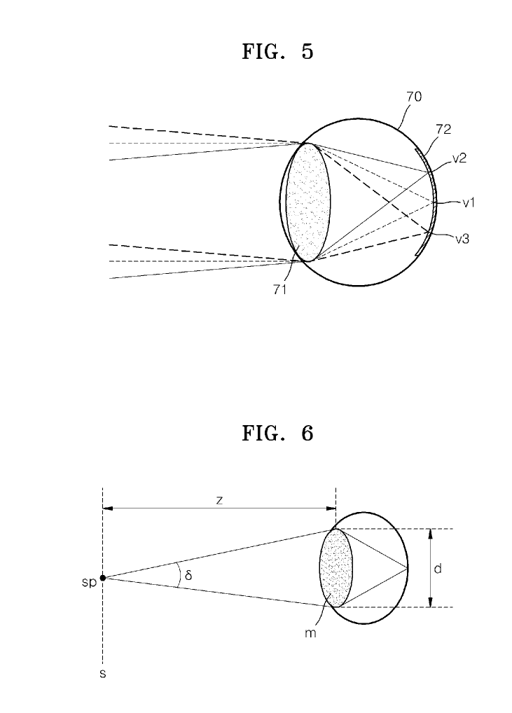

FIG. 5 illustrates an example of images having a plurality of viewing points being formed on a retina of a viewer according to an operation of a 3D display apparatus. For example, images having first through third viewing points may pass through a pupil 71 of an eyeball 70 of a viewer, and each may be independently formed on a retina 72 of the viewer. According to a time-division manner, an image having a first viewing point v1 may be first formed on the retina 72, and then images having second and third viewing points v2 and v3 may be formed on the retina 72. The images having the first through third viewing points v1, v2, and v3 may be almost simultaneously formed on the retina 72 by adjusting an operation speed of an active optical device. For example, if a frame rate by which images of one frame are displayed is approximately 60 Hz, by adjusting an operation frequency of the active optical device at each viewing point to be about 180 Hz, the viewer may observe images having three viewing points while hardly experiencing a parallax due to a display of the images having three viewing points.

FIG. 6 illustrates an example of multi-view or super multi-view 3D images being realized in a 3D display apparatus by adjusting a pixel angle pitch of a pixel on a screen according to a distance between the screen s and a pupil m of a viewer. The pixel on the screen s is referred to as a 3D point sp, a distance (a viewing distance) between the 3D point sp and the pupil m of the viewer is referred to as z, and a diameter of the pupil m is referred to as d. An angle between the two radial lines connecting the 3D point sp and side end points of the pupil m is referred to as a pixel angle pitch δ. If z is relatively larger than d, the pixel angle pitch δ may be defined as shown in Equation 1.

δ≈ tan−1(d/z) <Equation 1>

A pixel angle pitch for satisfying a super multi-view condition, as defined by Equation 1, in a projection type multi-view 3D display apparatus may be converted into data according to a viewing distance and a size of a pupil. For example, a viewing distance corresponding to a mobile display may be approximately 0.3 m, a viewing distance corresponding to a monitor may be approximately 0.7 m, and a viewing distance corresponding to a television (TV) may be approximately 3 m. With respect to these three cases, if a diameter d of a pupil is approximately 5 mm on an average, a pixel angle pitch for realizing super multiple views may respectively be approximately 0.955, 0.409, and 0.095 (degrees). As a viewing distance increases, a pixel angle pitch for realizing super multiple views or multiple views may correspondingly decrease. The pixel angle pitch for realizing the super multiple views or the multiple views may be adjusted by changing a rotation angle of an active optical device or by changing a slope angle of a refractive surface.

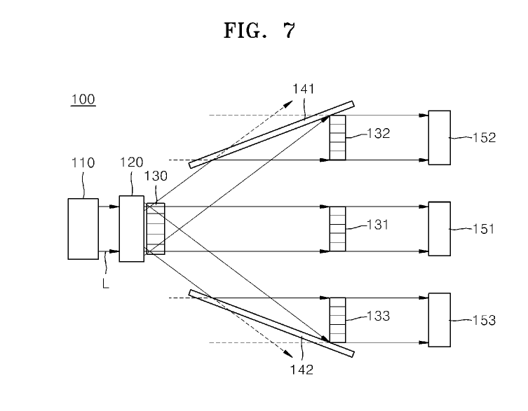

FIG. 7 illustrates a further example of a 3D display apparatus 100. The 3D display apparatus 100 may include a light source 110, an active optical device 120 for selectively changing a path of light emitted from the light source 110, and a display panel 130 for generating an image according to the light emitted from the active optical device 120. As described above, the active optical device 120 may be a rotational optical plate or an electro-wetting prism with an adjustable refractive surface. According to an operation of the active optical device 120, images generated by the display panel 130 may be formed as virtual intermediate images at different positions. A plurality of projection optical systems may be arranged so as to substantially correspond to the plurality of virtual images. As an example, one or more mirrors may be disposed in paths of light that include the plurality of virtual images. Positions at which the plurality of virtual images are formed may be changed by the one or more mirrors. For example, a first mirror 141 may be disposed in an optical path between the display panel 130 and a projection optical system arranged at a first side from among the plurality of projection optical systems. Also, a second mirror 142 may be disposed in an optical path between the display panel 130 and a projection optical system at another side from among the plurality of projection optical systems.

Alternatively, positions of the active optical device 120 and the display panel 130 may be switched. In this case, the first mirror 141 may be disposed in an optical path between the active optical device 120 and a projection optical system arranged at a first side from among the plurality of projection optical systems. Also, the second mirror 142 may be disposed in an optical path between the active optical device 120 and a projection optical system arranged at another side from among the plurality of projection optical systems, so that the first mirror 141 and the second mirror 142 may respectively reflect light including virtual images from the active optical device 120.

As an example, according to a time-division manner, a first virtual image 131, a second virtual image 132, and a third virtual image 133 may be generated from images formed by the display panel 130. A first projection optical system 151 for projecting the first virtual image 131, a second projection optical system 152 for projecting the second virtual image 132, and a third projection optical system 153 for projecting the third virtual image 133 may be included in the 3D display apparatus 100. The first mirror 141 may be disposed in an optical path between the display panel 130 (or the active optical device 120) and the second projection optical system 152, and the second mirror 142 may be disposed in an optical path between the display panel 130 (or the active optical device 120) and the third projection optical system 153. The first mirror 141 may be used to adjust a position at which the second virtual image 132 is formed. Also, the second mirror 142 may be used to adjust a position at which the third virtual image 133 is formed. Accordingly, an interval between the plurality of virtual images may be adjusted, and an interval between any two of a plurality of viewing points may be adjusted accordingly. By decreasing the interval between viewing points of the plurality of viewing points, images having more viewing points may be displayed, and a size of the 3D display apparatus 100 may be decreased.

Operations of the 3D display apparatus 100 are further described below. In an example where the active optical device 120 is formed as a rotational optical plate, when the optical plate does not rotate but maintains a substantially vertical state, an image having a first viewing point generated by the display panel 130 is formed as a first virtual image 131 at a first position. The operations of the 3D display apparatus 100 are similar to those described above with reference to FIGS. 2A through 2C, and thus detailed descriptions thereof are omitted here. If the optical plate is sloped by a first angle, light including an image having a second viewing point generated by the display panel 130 is reflected at the first mirror 141, and thus the image having the second viewing point is formed as a second virtual image 132 at a second position. If the optical plate is sloped by a second angle, light including an image having a third viewing point generated by the display panel 130 is reflected at the second mirror 142, and thus the image having the third viewing point may be formed as a third virtual image 133 at a third position.

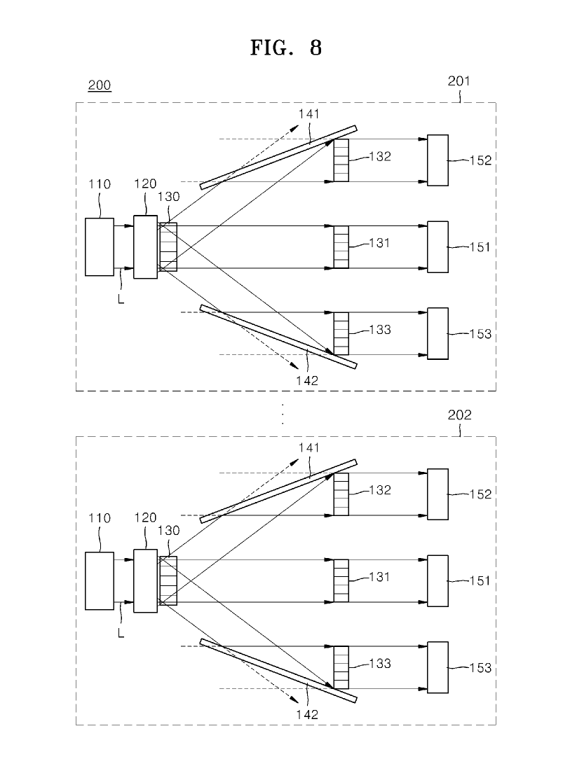

FIG. 8 illustrates an example of a 3D display apparatus 200 that includes a plurality of projection systems. In the 3D display apparatus 100 of FIG. 7, multi-view or super multi-view 3D images are displayed by generating a plurality of virtual images with one projection system. The 3D display apparatus 200 of FIG. 8 may include a plurality of projection systems 201 and 202, and each of the plurality of projection systems 201 and 202 may include substantially the same configuration as that shown in FIG. 7. For example, in an example where three projection systems are arranged, and each of the three projection systems generates three virtual images, images having a total of 9 viewing points may be displayed. In contrast to a 3D display apparatus that includes 9 projection systems to display images having 9 viewing points, a size of the 3D display apparatus may be decreased by including a plurality of projection systems. The projection systems 201 and 202 in the 3D display apparatus 200 may be substantially simultaneously driven and may separately generate virtual images in a time-division manner. Further, by increasing the number of virtual images generated in each of the projection systems, the number of projection systems may be decreased.

A method of displaying 3D images is described below. Referring to the 3D display apparatus 1 of FIG. 1, the light source 10 emits light L, and the display panel 15 generates images according to the light L. By selectively changing a travel path of light including the images, a plurality of virtual images may be generated. The travel path of light may be changed by the active optical device 20. The active optical device 20 may change the travel path of light including the images, and thus may generate the plurality of virtual images in a time-division manner. For example, the active optical device 20 may be a rotational optical plate or an electro-wetting prism. By projecting the virtual images to respective corresponding projection optical systems, images having a plurality of viewing points may be displayed. As described above, the method of displaying the 3D images as described herein may generate a plurality of intermediate images at an intermediate location of an optical path of a 3D display apparatus and thus may display multi-view or super multi-view images.

A method of displaying the 3D images as described herein may be one of various methods related to a Ray Field Reconstruction 3D Display that increases the number of viewing points and provides motion parallax. Furthermore, a 3D display apparatus as described herein may be reduced in size and may further efficiently increase the number of viewing points when 3D images are displayed by using the same number of projection systems. A 3D display apparatus as described herein may be applied to a super multi-view system, a high-density direction display system, a holo-vision system, or the like.

A 3D display apparatus and A method of displaying the 3D images as described herein may provide images having a plurality of viewing points in a time-division manner according to a active optical device for selectively changing a travel path of light. Thus, an increase of a size of a whole system may be prevented when increasing the number of viewing points.

Also, a 3D display apparatus as described herein may provide images having two or more viewing points to a retina of a viewer, so that the viewer may experience more natural 3D images with limited crosstalk. Also, the viewer may experience a 3D effect via only one eye.

A 3D display apparatus as described in the above examples may be included in an electronic device. As a non-exhaustive illustration only, an electronic device described herein may refer to mobile devices such as a portable game console, a portable/personal multimedia player (PMP), a portable lap-top PC, and devices such as a desktop PC, a high definition television (HDTV), and the like capable of wireless communication or network communication consistent with that disclosed herein.

It should be understood that the examples described herein should be considered in a descriptive sense only and not for purposes of limitation. Descriptions of features or aspects within each embodiment should typically be considered as available for other similar features or aspects in other embodiments. Further, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A three-dimensional (3D) display apparatus comprising:
a light source which emits light;
a display unit which generates images according to the light emitted from the light source;
an active optical device which changes a travel path of light comprising the images generated by the display unit, and which generates a plurality of virtual images in a time-division manner; and
a plurality of projection optical systems which respectively project the plurality of virtual images.

2. The 3D display apparatus of claim 1, wherein the active optical device comprises an optical plate which adjusts a refraction direction of light by adjusting a rotation angle of the optical plate.

3. The 3D display apparatus of claim 2, wherein the rotation angle of the optical plate is adjusted mechanically, electrically, or a combination thereof.

4. The 3D display apparatus of claim 1, wherein the active optical device comprises an electro-wetting prism having a refractive surface, a slope of which is changed by an application of a voltage to the active optical device.

5. The 3D display apparatus of claim 1, wherein the display unit comprises a Digital Micromirror Device (DMD).

6. The 3D display apparatus of claim 1, wherein:
a first mirror is disposed in an optical path between the active optical device and a first projection optical system from among the plurality of projection optical systems; and
a second mirror is disposed in an optical path between the active optical device and a second projection optical system from among the plurality of projection optical systems,
wherein the first mirror and the second mirror respectively reflect the light comprising the plurality of virtual images from the active optical device.

7. The 3D display apparatus of claim 1, wherein the display unit generates images having time-sequentially different viewing points.

8. The 3D display apparatus of claim 1, wherein the active optical device is substantially synchronized with the display unit, and wherein the active optical device refracts light comprising images having different viewing points by different angles.

9. The 3D display apparatus of claim 1, wherein the 3D display apparatus is included in a super multi-view system.

10. The 3D display apparatus of claim 1, wherein the 3D display apparatus is included in a high-density direction display system.

11. A method of displaying three-dimensional (3D) images, the method comprising:
emitting light from a light source;
generating images according to the light emitted from the light source, wherein the images are generated by a display unit;
changing a travel path of light comprising the images generated by the display unit, wherein an active optical device changes the travel path of the light comprising the images;
generating a plurality of virtual images in a time-division manner, wherein the active optical device generates the plurality of virtual images; and
projecting each of the plurality of virtual images respectively from each of a plurality of projection optical systems.

12. The method of claim 11, wherein the active optical device comprises an optical plate which adjusts a refraction direction of light by adjusting a rotation angle of the optical plate.

13. The method of claim 12, wherein a rotation angle of the optical plate is adjusted mechanically, electrically, or a combination thereof.

14. The method of claim 11, wherein the active optical device comprises an electro-wetting prism having a refractive surface, a slope of which is changed by an application of a voltage to the active optical device.

15. The method of claim 11, wherein the display unit comprises a Digital Micromirror Device (DMD).

16. The method of claim 11, wherein:
a first mirror is disposed in an optical path between the active optical device and a first projection optical system from among the plurality of projection optical systems; and
a second mirror is disposed in an optical path between the active optical device and a second projection optical system from among the plurality of projection optical systems,
wherein the first mirror and the second mirror respectively reflect the light comprising the plurality of virtual images from the active optical device.

17. The method of claim 11, wherein the display unit generates images having time-sequentially different viewing points.

18. The method of claim 11, wherein the active optical device is substantially synchronized with the display unit, and wherein the active optical device refracts light comprising images having different viewing points by different angles.

19. A three-dimensional (3D) display apparatus comprising:
a first projection system; and
a second projection system,
wherein each of the first and second projection systems comprise:
a light source which emits light;
a display unit which generates images according to the light emitted from the light source;
an active optical device which changes a travel path of light comprising the images generated by the display unit; and
a plurality of projection optical devices project virtual images according to an output of the active optical device.

20. The 3D display apparatus of claim 19, wherein the first and second projection systems are substantially simultaneously operated to separately generate respective virtual images in a time-division manner.

21. The 3D display apparatus of claim 19, further comprising one or more additional projection systems in addition to the first and second projection systems.
